(19) United States
(12) Patent Application Publication
(10) Pub. No.: US 2008/0268083 A1
(43) Pub. Date: Oct. 30, 2008

(54) Split Mold Inserts for a Molding System

(75) Inventor: Stephen Daniel FERENC, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/739,731

(22) Filed: Apr. 25, 2007

(51) Int. Cl. B28B 1/00

(52) U.S. Cl. 425/180

(57) ABSTRACT

According to embodiments of the present invention, there is provided a split mold insert. The split mold insert comprises a body comprising: a front face portion defining, in part, a first portion of a molding cavity; a planar upper face portion for cooperation with a complementary lower portion of a first mold insert, the first mold insert defining a second portion of the molding cavity; the planar upper face portion defining a split line between the first and second portions of the molding cavity; a locking interface defined on an outermost portion of the body, the locking interface configured to cooperate with a blocking member associated with a cavity mold insert.

### FIELD OF THE INVENTION

The present invention generally relates to, but is not limited to, molding systems, and more specifically the present invention relates to, but is not limited to, a split mold inserts for use in a molding system.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethelene terephalate (PET) material is a preform that is capable of being subsequently blown into a beverage container, such as, a bottle and the like.

As an illustration, injection molding of PET material involves heating the PET material (ex. PET pellets, PEN powder, PLA, etc.) to a homogeneous molten state and injecting, under pressure, the so-melted PET material into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, stripper rings and neck rings, ejector pins, etc.

When dealing with molding a preform that is capable of being blown into a beverage container, one consideration that needs to be addressed is forming a so-called “neck region”. Typically and as an example, the neck region includes (i) threads (or other suitable structure) for accepting and retaining a closure assembly (ex. a bottle cap), and (ii) an anti-pilferage assembly to cooperate, for example, with the closure assembly to indicate whether the end product (i.e. the beverage container that has been filled with a beverage and shipped to a store) has been tampered with in any way. The neck region may comprise other additional elements used for various purposes, for example, to cooperate with parts of the molding system (ex. a support ledge, etc.). As is appreciated in the art, the neck region can not be easily formed by using the cavity and core halves. Traditionally, split mold inserts (sometimes referred to by those skilled in the art as “neck rings”) have been used to form the neck region.

With reference to FIG. 1, a section along a portion of an injection mold 50 illustrates a typical molding insert stack assembly 52 that is arranged within a molding system (not depicted). The description of FIG. 1 that will be presented herein below will be greatly simplified, as it is expected that one skilled in the art will appreciate configuration of other components of the injection mold 50 that will not be discussed in the following description

The molding insert stack assembly 52 includes a neck ring insert pair 54 that together with a mold cavity insert assembly 56, a gate insert 58 and a core insert assembly 60 defines a molding cavity 62 where molding material can be injected to form a molded article. In order to facilitate forming of the neck region of the molded article and subsequent removal of the molded article, the neck ring insert pair 54 comprises a pair of complementary neck ring inserts that are mounted on adjacent slides of a slide pair (not depicted). The slide pair is slidably mounted on a top surface of a stripper plate (not depicted). As commonly known, and as, for example, generally described in U.S. Pat. No. 6,799,962 to Mai et al (granted on Oct. 5, 2004), the stripper plate is configured to be movable relative to the cavity insert assembly 56 and the core insert assembly 60, when the mold is arranged in an open configuration, whereby the slide pair, and the complementary neck ring inserts mounted thereon, can be laterally driven, via a cam arrangement (not shown), for the release of the molded article from the molding cavity 62.

A typical neck ring insert has a body that includes a pair of projecting portions 66 that extend from a top and a bottom face of a flange portion 68 (i.e. a bottom projecting portion 66a and a top projecting portion 66b).

With further reference to FIG. 2, it is commonly known to produce two types of preforms, amongst others, a straight preform 70 and a bell shape preform 72. The straight preform 70 is generally categorized by a relatively long major draft length 74, whereby the bell shape preform 72 is generally categorized by a relatively short major draft length 76. The straight preform 70 having the relatively long major draft length 74 can be said to be a “transfer-friendly preform” in that it can be easily aligned with a cooling tube for problem-free transfer at an appropriate portion of a molding cycle (i.e. during molded article transfer between the core insert 60 assembly and a cooling tube). The bell shape preform 74 having the relatively short major draft length 76, on the other hand, can be said to be a “transfer-unfriendly preform” in that the cooling tube has to be placed in close proximity to the neck ring insert pair 54 holding the bell shape preform 72 during the appropriate portion of the molding cycle (i.e. during molded article transfer between the core assembly and the cooling tube). However, the close proximity of the cooling tube relative to the neck ring insert pair 54 limits the number of transfer stations (i.e. so-called cooling positions) that can be placed within a horizontal pitch of the mold due to physical space limitations created by the aforementioned top projecting portion 66b of the neck ring insert pair 54 and potential collision between the neck ring insert pair 54 and an adjacent bell shape preforms 72 already being cooled.

This problem is best illustrated with reference to FIG. 3. FIG. 3 depicts a plurality of cooling tubes 78 and, more specifically, a first cooling tube 78a, a second cooling tube 78b and a third cooling tube 78c. In this particular illustration, the plurality of cooling tubes 78 can be said to correspond to a three-position post-mold cooling cycle. FIG. 3 further depicts a plurality of bell shape preforms—a first bell shape preform 72a, a second bell shape preform 72b and a third bell shape preform 72c. The third bell shape preform 72c is shown in a fully received position within the third cooling tube 78c and can be said to be associated with a third position of a three-position post-molding cooling cycle. The second bell shape preform 72b is shown in a fully received position within the second cooling tube 78b and can be said to be associated with a second position of a three-position post-molding cooling cycle. The first bell shape preform 72a is shown in a partially received position within the first cooling tube 78a and can be said to be associated with a first position of a three-position post-molding cooling cycle.

As can be further seen in FIG. 3, the plurality of cooling tubes 78 need to be positioned substantially close to the neck rings 54, as depicted by a distance 90. The distance 90 is determined such that the first bell shape preform 72a is pre-positioned and substantially aligned within a receptacle 84 of the first cooling tube 78a before being fully removed from the neck ring insert pair 54 and the core insert assembly (not depicted). This, however, causes a collision problem, as is clearly marked at 82 in FIG. 3. More specifically, upon a lateral movement of halves of the neck ring pair 54 associated with the first bell shape preform 72a, the top projecting portion 66b of a left half (as is seen in FIG. 3) collides with a second bell shape preform 72b being cooled in the second cooling tube 78b.

One simple solution to this problem is, of course, to space apart the second cooling tube 78b relative to the first cooling tube 78a in a direction depicted in FIG. 3 at “A”. This spacing apart should provide sufficient clearance for the second bell shape preform 78b to clear the top projecting portion 66b of the neck ring 54 associated with the first bell shape preform 72a. Albeit easy, this solution is not viable from the economic perspective of operating a molding system. More specifically, this arrangement would result in a wasted real estate of the take-off plate. Furthermore, such an arrangement would significantly reduce the number of post-mold cooling positions available for a given layout of a mold (i.e. would be limited to 1 or 2 positions post-mold cooling cycle). Overall, this spacing apart solution is not considered to be a commercially viable solution to this problem.

### SUMMARY OF THE INVENTION

According to a first broad aspect of the present invention, there is provided a split mold insert for producing a preform capable of being blow molded into a container. The split mold insert comprises a body comprising a front face portion defining, in part, a first portion of a molding cavity; a planar upper face portion for cooperation with a complementary lowermost portion of a first mold insert, the first mold insert defining a second portion of the molding cavity; the planar upper face portion defining a split line between the first and second portions of the molding cavity; a locking interface defined on an outermost portion of the body, the locking interface configured to cooperate with a blocking member associated with a cavity mold insert.

According to a second broad aspect of the present invention, there is provided a mold insert stack for producing a preform capable of being blow molded into a container. The mold insert stack comprises a cavity assembly for housing a cavity mold insert for defining a first portion of a molding cavity, the cavity mold insert including a lowermost portion; a blocking member defined along a portion of the lowermost portion; a split mold insert comprising a body defining: a front face portion defining, in part, a second portion of the molding cavity; a planar upper face portion for cooperation with the lowermost portion of the cavity mold insert; together defining a split line between the first and second portions of the molding cavity; a locking interface defined on an outermost portion of the body, the locking interface configured to cooperate with the blocking member.

According to a third broad aspect of the present invention, there is provided a molding system that incorporates the mold insert stack.

According to a fourth broad aspect of the present invention, there is provided a core lock type split mold insert for producing a preform capable of being blow molded into a container. The core lock type split mold insert comprises a body defining an upper planar face portion and a bottom planar face portion, the upper planar face portion being disposed in a single plane extending between a front face portion and an outermost portion of the body; a lower taper portion protruding from the bottom planar face portion; a first length measured between the upper and bottom planar face portions, a second length associated with the split mold insert, wherein a difference between the second length and the first length is contributed to exclusively by a third length associated with the lower taper portion.

According to another broad aspect of the present invention, there is provided a cavity lock type split mold insert for producing a preform capable of being blow molded into a container. The cavity lock type split mold insert comprises a body defining an upper planar face portion and a bottom planar face portion, the upper planar face portion being disposed in a single plane extending between a front face portion and an outermost portion of the body; a total length measured between the upper and bottom planar face portions, the total length being substantially constant as measured at any given point between the front face portion and the outermost portion.

According to another broad aspect of the present invention, there is provided a split line defined between an upper planar face portion of a split mold insert and a lowermost portion of a cooperating mold insert, the split line being substantially planar and extending between an outermost portion and a back face portion of the split mold insert, the split mold insert for producing a preform capable of being blow molded into a container.

According to yet another broad aspect of the present invention, there is provided a split mold insert for producing a preform capable of being blow molded into a container, consisting essentially of a body defining (i) a front face portion a front face portion defining, in part, a portion of a molding cavity, (ii) an outermost portion on an opposite extreme of the body relative to the front face portion, (iii) a bottom face portion and (iv) an upper face portion; the upper face portion being disposed in a single plane extending between the front face portion and the outermost portion.

A technical effect, amongst others, of the aspects of the present invention may include increased system output of bell shape preforms by utilizing appropriate number of positions for the post-mold cooling cycle (for example, 3 or 4 positions post-mold cooling cycle). Another technical effect of the present invention, may include reduced neck ring wear and, as a result, potential decreased costs associated with replacing worn neck rings. It should be expressly understood that not all of the technical effects, in their entirety, need be realized in all and every embodiments of the present invention.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 is a section view along a portion of an injection mold 50 with a neck ring insert pair 54 according to a prior art solution.

FIG. 2 is a schematic view of two known types of a preform, amongst others, a straight preform and a bell shape preform.

FIG. 3 is a schematic view of bell shape preforms at various stages of a post-mold cooling cycle, illustrating interaction between cooling tubes and neck ring insert pair 54 according to prior art solutions.

FIG. 4 illustrates a section view of a portion of an injection mold stack that includes split mold inserts according to a non-limiting embodiment of the present invention.

FIG. 5 is a perspective view of the split mold inserts of the injection mold stack of FIG. 4, according to a non-limiting embodiment of the present invention.

FIG. 6 is a perspective view of a cavity mold assembly and the associated blocking members according to a non-limiting embodiment of the present invention.

FIG. 7 is a schematic view of bell shape preforms at various stages of a post-mold cooling cycle, illustrating interaction between cooling tubes and the split mold inserts according to a non-limiting embodiment of the present invention.

FIG. 8 is a perspective view of split mold inserts according to another non-limiting embodiment of the present invention.

FIG. 9 is a cross section of the split mold inserts of FIG. 8, according to a non-limiting embodiment of the present invention, taken along lines 9-9.

FIG. 10 is a cross section of a mold in a mold closed position incorporating the injection mold stack of FIG. 4 and the cavity mold assembly of FIG. 6.

### DETAILED DESCRIPTION OF EMBODIMENTS

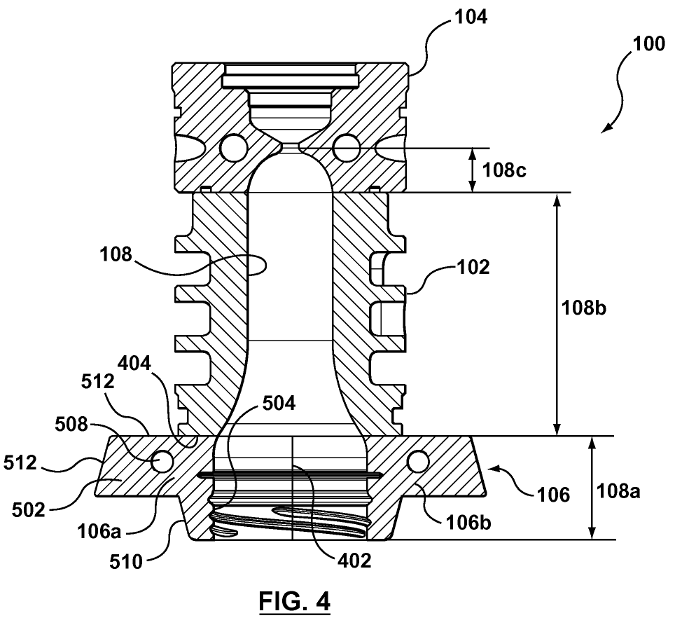

With reference to FIG. 4, a non-limiting embodiment of a mold insert stack 100, which can implement split mold inserts according to various non-limiting embodiments of the present invention, is depicted. The mold insert stack 100 comprises a cavity insert 102, a gate insert 104 and a split mold insert pair 106 (referred to sometimes herein below as “neck ring pair” 106). The cavity insert 102, the gate insert 104 and the neck ring pair 106 define, together with a core insert (not depicted) and a lock ring (not separately numbered), a molding cavity 108. More specifically, the neck ring pair 106 can be said to define a neck portion 108a of the molding cavity 108. The cavity insert 102 can be said to define a body portion 108b of the molding cavity 108. The gate insert 104 can be said to define an end portion 108c of the molding cavity 108. These portions can also be thought of as a first, a second and a third portions in any combination thereof.

In use, the molding cavity 108 is filled under pressure with melt (such as, for example, molten plastic) and a molded article is formed. Examples of the molded article that can be formed according to embodiments of the present invention include the bell shape preform 72.

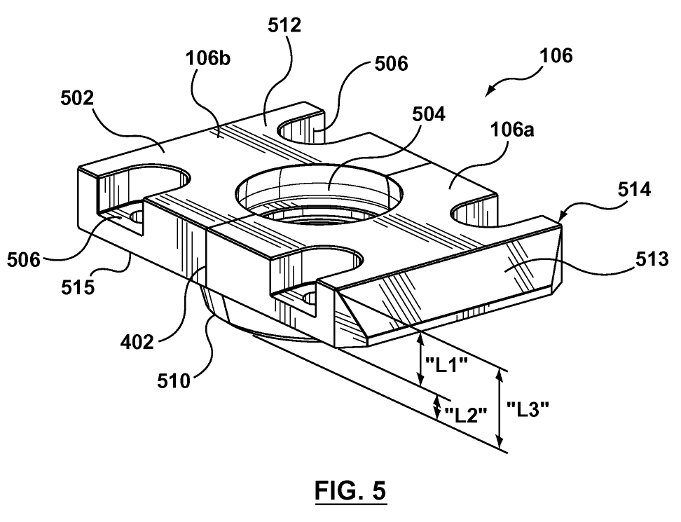

With continued reference to FIG. 4 and with further reference to FIG. 5, configuration of the neck ring pair 106 will now be described in greater details. The neck ring pair 106 comprises a first neck ring half 106a and a second neck ring half 106b joined together at a joining line 402. It should be understood that the first neck ring half 106a and the second neck ring half 106b can be substantially mirror images of each other and, as such, when one of the first neck ring half 106a and the second neck ring half 106b is described herein below as comprising a particular element, it can be said that the other one of the first neck ring half 106a and the second neck ring half 106b comprises a mirror image of the same component.

With this in mind, the second neck ring half 106b comprises a body 502. The body 502 comprises a front face portion 504 that defines a portion of the aforementioned molding cavity 108. More precisely, the front face portion 504 defines a portion of the neck portion 108a of the molding cavity 108. The body 502 further comprises a plurality of connecting interfaces 506 for connecting the second neck ring half 106b to a neck ring slide (not depicted) for integral movement, in use, therewith. In the specific non-limiting embodiment being described herein, each of the plurality of connecting interfaces 506 comprises a respective receptacle for accepting a respective bolt. However, other known types of a connecting interface 506 can be used. The body 502 further comprises a cooling channel 508, which connects, in use, to a source of coolant (such as water and the like), as is known in the art. It should be understood that in an alternative non-limiting embodiment of the present invention, the cooling channel 508 may have other configurations or may be omitted altogether. The body 502 further comprises a lower taper edge 510. The lower taper edge 510 comprises a male taper and cooperates, in use, with a complementary female taper portion of a lock ring (not depicted) associated with a core (not depicted). The lock ring can be thought of as yet another mold insert component. Accordingly, in the embodiment depicted in FIG. 5 (and FIG. 4), the neck ring pair 106 can be said to be of a “core lock design type”.

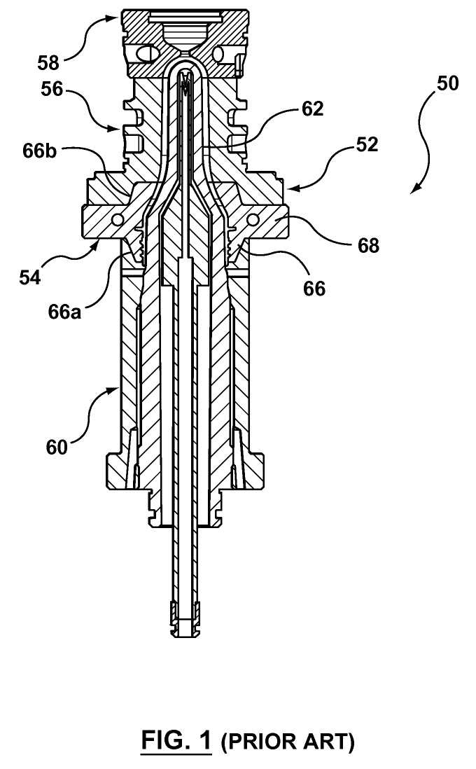

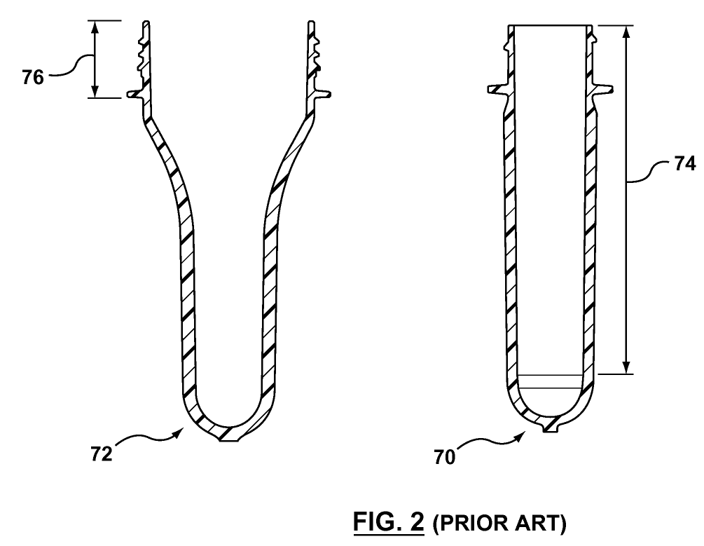

The body 502 of the second neck ring half 106b defines an upper face portion 512 and a bottom face portion 515. As is best seen in FIG. 4, the upper face portion 512 of the body 502 of the second neck ring half 106b abuts, in use, a lower portion of the cavity insert 102. The lower portion of the cavity insert 102 can be said to be the lowermost portion of the lower portion of the cavity insert 102. The upper face portion 512 can be said to be substantially planar. For the avoidance of doubt the upper face portion 512 is said to be planar in the sense that it does not include any protrusions (such as, for example, a top taper portion similar to the top projecting portion 66b of the prior art design of FIG. 1). As can be seen in FIG. 5, the body 502 can be said to be associated with a first length “L1” as measured between the upper face portion 512 and the bottom face portion 515. The lower taper edge 510 can be said to be associated with a second length “L2”. The second neck ring half 106b, as the whole, can be said to be associated with a third length “L3” measured from the upper face portion 512 to a lowest extreme of the lower taper edge 510. It is worthwhile noting that a difference between the third length L3 and the first length L1 is contributed to exclusively by the second length L2.

A split line 404 is defined where the upper face portion 512 of the body of the second neck ring half 106b meets the lower portion of the cavity insert 102. Put another way, it can be said that the neck portion 108a of the molding cavity 108 and the body portion 108b of the molding cavity meet at the split line 404. As is appreciated by those skilled in the art, the split line 404 will leave, in use, a corresponding witness line on the molded article (i.e. the bell shape preform 72). As can be seen in FIG. 5, the upper face portion 512 is substantially planar and does not include an upper protrusion similar, for example, to the top projecting portion 66b of the prior art design of FIG. 1.

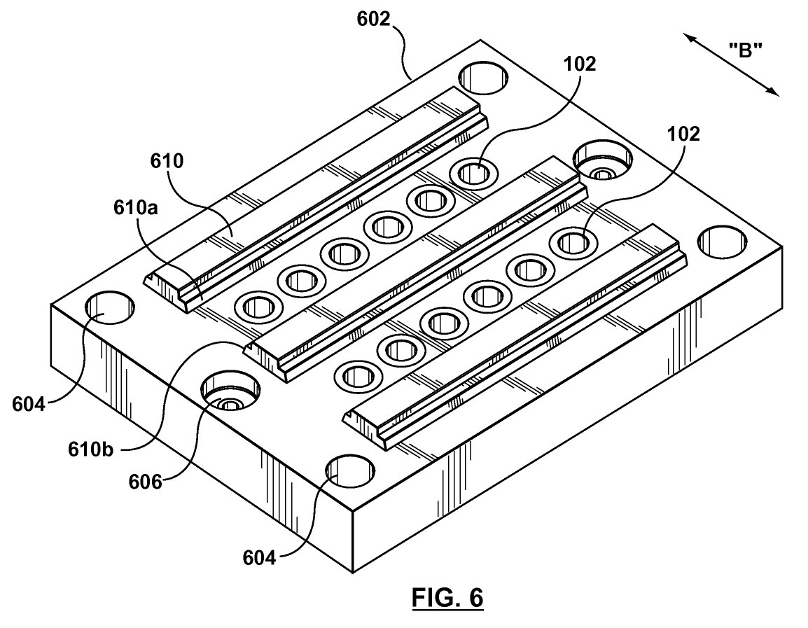

The body 502 further includes a locking interface 513. The locking interface 513 is defined on an outermost portion 514 of the body 502. For the avoidance of doubt, the outermost portion 514 is located at a very extreme portion of the body 502 opposite the front face portion 504. In the embodiment depicted in FIG. 5, the locking interface 513 comprises a taper member. With further reference to FIG. 6, operation of the locking interface 513 will be discussed in greater detail. More specifically, FIG. 6 depicts a cavity assembly 602 for housing a plurality of cavity inserts 102. The cavity assembly 602 comprises a plurality of alignment members 604 that are used, in operation, to align the cavity assembly 602 with the core assembly (not depicted). The cavity assembly 602 further comprises a plurality of locking members 606 that used, in operation, to precisely align the cavity assembly 602 and the core assembly (not depicted) it in an operating position. More specifically, each of the locking members 606 comprises a respective tapered bore for accepting a complementary locking member associated with the core assembly (not depicted). It should be expressly understood that the configuration of the plurality of alignment members 604 and the locking members 606 may be implemented in a number of alternatives as will be appreciated by those of skill in the art.

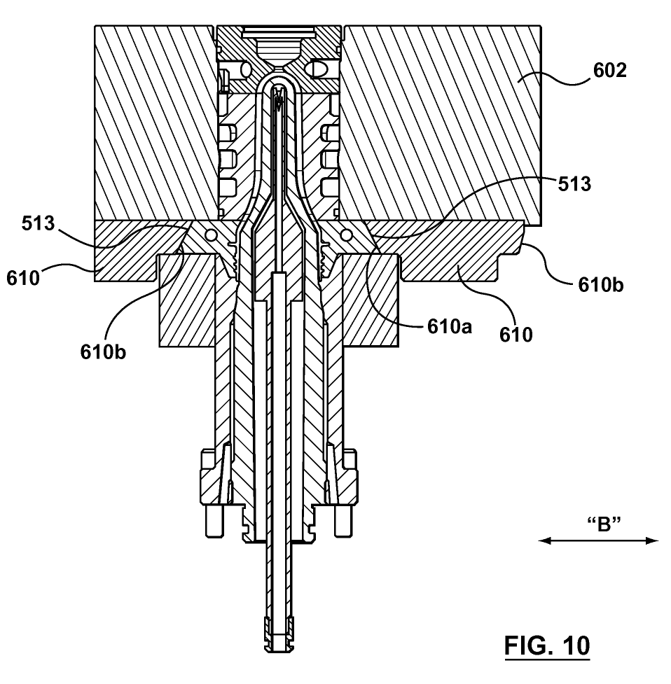

The cavity assembly 602 further comprises a plurality of blocking members 610. Each of the plurality of blocking members 610 comprises a first taper portion 610a and a second taper portion 610b. With continued reference to FIG. 6 and with continued reference to FIG. 10, in the mold closed position, the first taper portion 610a and the second taper portion 610b cooperate with a respective locking interface 513 to prevent the first neck ring half 106a and the second neck ring half 106b from any substantial movement in a direction depicted in FIG. 6 and FIG. 10 at “B”. In some embodiments of the present invention, each of the plurality of blocking members 610 may be made from a relatively soft material. Some examples of the materials that can be used include, but are not limited to, Ampco™ bronze, pre-hardened steel with applied surface coating of bronze, Wearitite™, graphite or another suitable wear material. An additional technical effect of these embodiments of the present invention may include less wear associated with the neck ring pair 106, as most of the wear will be inflicted on the plurality of blocking members 610. As such, another technical effect of these embodiments of the present invention may included decreased operating costs, as some of the plurality of blocking members 610 may be less costly to replace as compared to the cost to replace one or more of the neck ring pairs 106 due to premature fatigue. Yet another technical effect of these embodiments of the present invention may include a simpler structure.

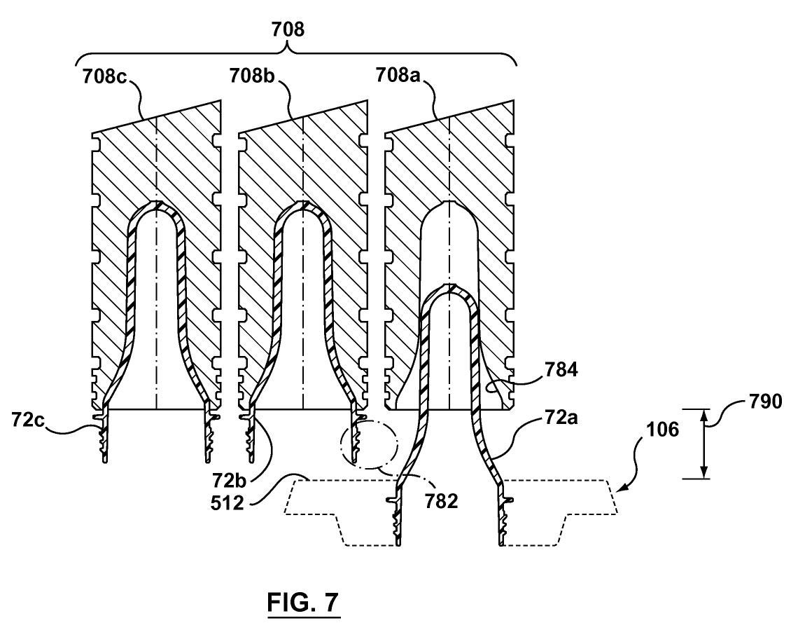

Transfer operation of the neck ring insert pair 54 can be best seen with reference to FIG. 7. FIG. 7 depicts a plurality of cooling tubes 708 and, more specifically, a first cooling tube 708a, a second cooling tube 708b and a third cooling tube 708c. In this particular illustration, the plurality of cooling tubes 708 can be said to correspond to a three-position post-mold cooling cycle. FIG. 7 further depicts a plurality of bell shape preforms—a first bell shape preform 72a, a second bell shape preform 72b and a third bell shape preform 72c. The third bell shape preform 72c is shown in a fully received position within the third cooling tube 708c and can be said to be associated with a third position of a three-position post-molding cooling cycle. The second bell shape preform 72b is shown in a fully received position within the second cooling tube 708b and can be said to be associated with a second position of a three-position post-molding cooling cycle. The first bell shape preform 72a is shown in a partially received position within the first cooling tube 708a and can be said to be associated with a first position of a three-position post-molding cooling cycle.

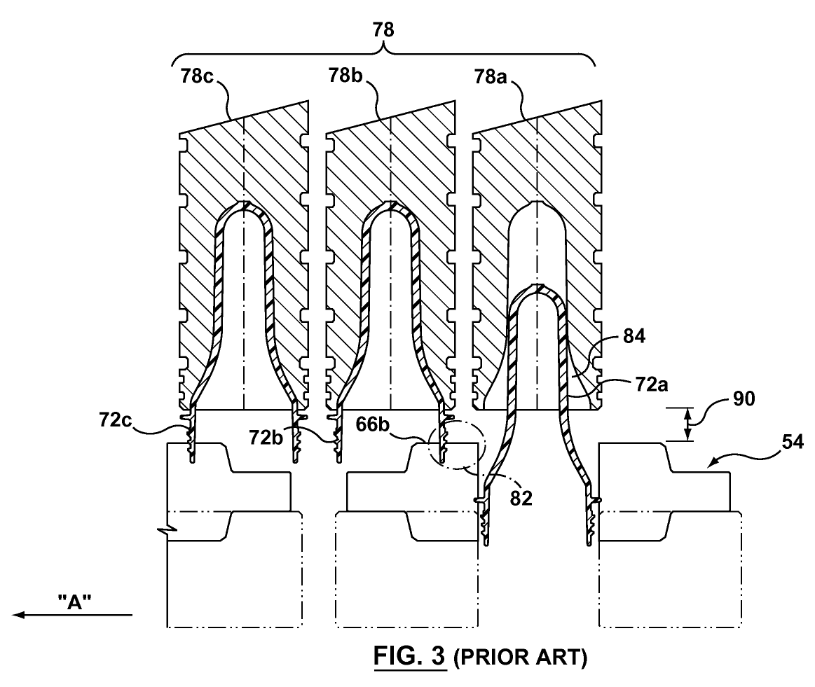

The plurality of cooling tubes 708 are positioned substantially close to the neck ring pair 106, as depicted by a distance 790. The distance 790 is determined such that the first bell shape preform 72a is pre-positioned and substantially aligned within a receptacle 784 of the first cooling tube 708a before being fully removed from the split mold insert pair and the core insert assembly (not depicted). However, unlike the arrangement shown in FIG. 3, the arrangement depicted in FIG. 7 and, more specifically, the configuration of the upper face portion 512 substantially prevents any collision between the neck ring pair 106 and the second bell shape preform 72b as is shown schematically in FIG. 7 at 782. In other words, the neck ring pair 106 can be said to lack an element similar to the top projecting portion 66b of the neck ring insert pair 54 of the prior art. Accordingly, a technical effect of the configuration of the upper face portion 512 of the neck ring pair 106 may include ability to maintain the appropriate distance 790, while avoiding collision with other bell shape prefoms (such as, for example, the second bell shape preform 72b). Another technical effect of the embodiments of the present invention may include increased flexibility as to a number of positions of the post-mold cooling cycle (for example, 3 or 4 positions of the post-mold cooling cycle).

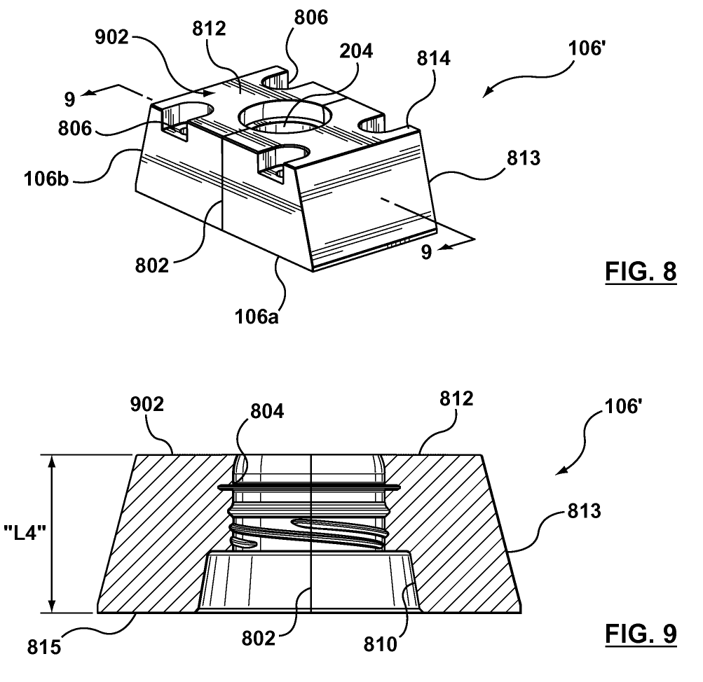

It should be expressly understood that the configuration of the neck ring pair 106 may be implemented in a number of alternative configuration. With reference to FIG. 8 and FIG. 9 a neck ring pair 106′ according to another non-limiting embodiment of the present invention will now be discussed in greater detail.

The neck ring pair 106′ comprises a first neck ring half 106a′ and a second neck ring half 106b′ joined together at a joining line 802. It should be understood that the first neck ring half 106a′ and the second neck ring half 106b′ can be substantially mirror images of each other and, as such, when one of the first neck ring half 106a′ and the second neck ring half 106b′ is described herein below as comprising a particular element, it can be said that the other one of the first neck ring half 106a′ and the second neck ring half 106b′ comprises a mirror image of the same component.

The neck ring pair 106′ comprises a body 902. The body 902 comprises a front face portion 804 that defines a portion of the aforementioned molding cavity 108. More precisely, the front face portion 804 defines a portion of the neck portion 108a of the molding cavity 108. The body 902 further comprises a plurality of connecting interfaces 806 for connecting the second neck ring half 106b′ to a neck ring slide (not depicted) for integral movement, in use, therewith. The plurality of connecting interfaces 806 may be substantially similar to the plurality of connecting interfaces 506 described above.

The body 902 further comprises a lower taper edge 810. The lower taper edge 810 comprises a female taper and cooperates, in use, with a complementary male taper associated with a core (not depicted). Accordingly, in the embodiment depicted in FIG. 8 and FIG. 9, the neck ring pair 106′ can be said to be of a “cavity lock design type”.

The body 902 of the second neck ring half 106b′ defines an upper face portion 812 and a bottom face portion 815. The upper face portion 812 of the body 902 of the second neck ring half 106b′ abuts, in use, a lower portion of the cavity insert 102. A split line similar to the split line 404 of FIG. 4 is defined where the upper face portion 812 of the body 902 of the second neck ring half 106b′ meets the lower portion of the cavity insert 102.

The body 502 further includes a locking interface 813. The locking interface 813 is defined on an outermost portion 814 of the body 902. For the avoidance of doubt, the outermost portion 814 is located at a very extreme portion of the body 902 opposite the front face portion 804. In the embodiments depicted in FIG. 8 and FIG. 9, the locking interface 813 comprises a taper member. The operation of the locking interface 813 can be substantially similar to the operation of the locking interface 513 described above.

The second neck ring half 106b′ can be said to be associated with a total length depicted in FIG. 9 at “L4”. It is worthwhile noting that the total length L4 is measured exclusively between the upper face portion 812 and the bottom face portion 815. It is also worthwhile noting that the total length L4 is substantially constant as measured at any point between the outermost portion 814 and the front face portion 804.

It should be noted that even though the foregoing discussion has described the use of the neck ring pair 106 and the neck ring pair 106′ for use in an injection molding system suitable for forming bell shape preforms, one skilled in the art would appreciate that the neck ring pair 106 and the neck ring pair 106′ can be used in molding systems suitable for forming other types of preforms (such as, for example, straight preforms and the like). For the avoidance of doubt, it should be expressly understood that embodiments of present invention may be used in other types of molding systems such as, but not limited to, compression molding systems, metal molding systems and the like. It should be further understood that embodiments of the present invention are applicable to molding systems incorporating any multicavitation mold, including PET molds, thinwall articles molds, closures molds and the like.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A split mold insert for producing a preform capable of being blow molded into a container, the split mold insert comprising:
a body comprising:
a front face portion defining, in part, a first portion of a molding cavity;
a planar upper face portion for cooperation with a complementary lowermost portion of a first mold insert, the first mold insert defining a second portion of the molding cavity; said planar upper face portion defining a split line between the first and second portions of the molding cavity;
a locking interface defined on an outermost portion of said body, said locking interface configured to cooperate with a blocking member associated with a cavity mold insert.

2. The split mold insert of claim 1, wherein said planar upper face portion is disposed in a single plane extending between said front face portion and said outermost portion

3. The split mold insert of claim 1, wherein said preform is a bell shape preform.

4. The split mold insert of claim 1, wherein said preform is a straight shape preform.

5. The split mold insert of claim 1, wherein said locking interface comprises a taper portion.

6. The split mold insert of claim 1, implemented as a core lock split mold insert.

7. The split mold insert of claim 6, wherein said body further comprises a lower taper portion for cooperation, in use, with a taper portion associated with a lock ring.

8. The split mold insert of claim 7, wherein said lower taper portion comprises a male taper and wherein the taper portion associated with a lock ring comprises a complementary female taper.

9. The split mold insert of claim 1, implemented as a cavity lock split mold insert.

10. The split mold insert of claim 9, wherein said body further comprises a lower taper portion for cooperation, in use, with a taper portion associated with a core assembly.

11. The split mold insert of claim 10, wherein said lower taper portion comprises a female taper and wherein the taper portion associated with a core assembly comprises a complementary male taper.

12. A mold insert stack for producing a preform capable of being blow molded into a container, the mold insert stack comprising:
a cavity assembly for housing a cavity mold insert for defining a first portion of a molding cavity, the cavity mold insert including a lowermost portion;
a blocking member defined along a portion of the lowermost portion;
a split mold insert comprising a body defining:
a front face portion defining, in part, a second portion of the molding cavity;
a planar upper face portion for cooperation with said lowermost portion of the cavity mold insert; together defining a split line between the first and second portions of the molding cavity;
a locking interface defined on an outermost portion of said body, said locking interface configured to cooperate with said blocking member.

13. The mold insert stack of claim 12, wherein said planar upper face portion is disposed in a single plane extending between said front face portion and said outermost portion

14. The mold insert stack of claim 12, wherein said preform is a bell shape preform.

15. The mold insert stack of claim 12, wherein said preform is a straight shape preform.

16. The mold insert stack of claim 12, wherein said locking interface comprises a taper portion.

17. The mold insert stack of claim 12, implemented as a core lock split mold insert.

18. The mold insert stack of claim 17, wherein said body further comprises a lower taper portion for cooperation, in use, with a taper portion associated with a locking ring.

19. The mold insert stack of claim 18, wherein said lower taper portion comprises a male taper and wherein the taper portion associated with a locking ring comprises a complementary female taper.

20. The mold insert stack of claim 12, implemented as a cavity lock split mold insert.

21. The mold insert stack of claim 20, wherein said body further comprises a lower taper portion for cooperation, in use, with a taper portion associated with a core assembly.

22. The mold insert stack of claim 21, wherein said lower taper portion comprises a female taper and wherein the taper portion associated with a core assembly comprises a complementary male taper.

23. A molding system incorporating the mold insert stack of claim 12.

24. The molding system of claim 23, implemented in an injection molding system.

25. The molding system of claim 24, implemented in an injection molding system capable of producing bell shape preforms capable of being blow molded into a beverage container.

26. A core lock type split mold insert for producing a preform capable of being blow molded into a container, the core lock type split mold insert comprising:
a body defining an upper planar face portion and a bottom planar face portion, said upper planar face portion being disposed in a single plane extending between a front face portion and an outermost portion of said body;
a lower taper portion protruding from said bottom planar face portion;
a first length measured between said upper and bottom planar face portions,
a second length associated with the split mold insert, wherein a difference between said second length and said first length is contributed to exclusively by a third length associated with said lower taper portion.

27. The core lock type split mold insert of claim 26, wherein said front face portion defining, in part, a neck region of the preform.

28. The core lock type split mold insert of claim 27, wherein said preform is one of a bell shape preform and a straight shape preform.

29. The core lock type split mold insert of claim 26, wherein said outermost portion comprises a locking interface configured to cooperate with a blocking member to hold the split mold insert in an operating position.

30. The core lock type split mold insert of claim 29, wherein said locking interface comprises a taper portion.

31. A cavity lock type split mold insert for producing a preform capable of being blow molded into a container, the cavity lock type split mold insert comprising:
a body defining an upper planar face portion and a bottom planar face portion, said upper planar face portion being disposed in a single plane extending between a front face portion and an outermost portion of said body;
a total length measured between said upper and bottom planar face portions, said total length being substantially constant as measured at any given point between said front face portion and said outermost portion.

32. The cavity lock type split mold insert of claim 31, wherein said body further comprises a lower taper portion for cooperation, in use, with a taper portion associated with a core assembly, wherein said lower taper portion comprises a female taper and wherein the taper portion associated with a core assembly comprises a complementary male taper, wherein a difference in said total length is contributed to exclusively by a length of said female taper.

33. The cavity lock type split mold insert of claim 31, wherein said body further defines a front face portion defining, in part, a portion of a neck region of the preform;

34. The cavity lock type split mold insert of claim 31, wherein said preform is a bell shape preform.

35. The cavity lock type split mold insert of claim 31, wherein said preform is a bell shape preform.

36. The cavity lock type split mold insert of claim 31, wherein said outermost portion comprises a locking interface configured to cooperate with a blocking member to hold the split mold insert in an operating position.

37. The cavity lock type split mold insert of claim 36, wherein said locking interface comprises a taper portion.

38. A split line defined between an upper planar face portion of a split mold insert and a lowermost portion of a cooperating mold insert, the split line being substantially planar and extending between an outermost portion and a back face portion of the split mold insert, the split mold insert for use in a molding system for producing a preform capable of being blow molded into a container.

39. The split line of claim 38, wherein the outermost portion of the split mold insert further defines a locking interface, said locking interface configured to maintain the split mold insert in an operating position.

40. A split mold insert for producing a preform capable of being blow molded into a container, the split mold insert consisting essentially of:
a body defining (i) a front face portion a front face portion defining, in part, a portion of a molding cavity, (ii) an outermost portion on an opposite extreme of said body relative to said front face portion, (iii) a bottom face portion and (iv) an upper face portion; said upper face portion being disposed in a single plane extending between said front face portion and said outermost portion.
